(19) United States
(12) Patent Application Publication
(10) Pub. No.: US 2011/0022395 A1
(43) Pub. Date: Jan. 27, 2011

(54) Machine for Emotion Detection (MED) in a communications device

(75) Inventors: Alon Konchitsky, Santa Clara, CA (US); Sandeep Kulakcherla, Santa Clara, CA (US); Yaniv Konchitchki, Los Angeles, CA (US)

Correspondence Address: STEVEN A. NIELSEN;ALLMAN & NIELSEN, P.C., 100 Larkspur Landing Circle, Suite 212, LARKSPUR, CA, 94939, US

(73) Assignee: NOISE FREE WIRELESS INC., Santa Clara, CA (US)

(21) Appl. No.: 12/842,316

(22) Filed: Jul. 23, 2010

Related U.S. Application Data
(63) Continuation-in-part of application No. 11/675,207, filed on Feb. 15, 2007, now abandoned.

(51) Int. Cl. G10L 21/00

(52) U.S. Cl. 704/270

(57) ABSTRACT

A system and method monitors the emotional content of human voice signals after the signals have been compressed by standard telecommunication equipment. By analyzing voice signals after compression and decompression, less information is processed, saving power and reducing the amount of equipment used. During conversation, a user of the disclosed methodology may obtain information in various formats regarding the emotional state of the other party. The user may then view the veracity, composure, and stress level of the other party. The user may also view the emotional content of their own transmitted speech.

### CROSS-REFERENCE TO RELATED APPLICATIONS

This application claims the benefit of, and is a continuation in part of application Ser. No. 11/675,207 filed on Feb. 15, 2007 which in turn claims the benefit and priority date of provisional patent application 60/766,859 filed on Feb. 15, 2006 which is incorporated herein by reference.

### BACKGROUND OF THE INVENTION

(1) Field of the Invention

The invention relates to means and methods of measuring the emotional content of a human voice signal while the signal is in a compressed state.

(2) Description of the Related Art

Human speech carries various kinds of information. The detection of the emotional state of the speaker in utterances is crucial. This becomes difficult especially if the speech undergoes compression in a communication device.

Several attempts to monitor emotions in voice signals are known in the related art. However, the related art fails to provide the advantages of the present invention, which include means of measuring emotions in a compressed voice signal.

U.S. Pat. No. 6,480,826 to Pertrushin extracts an uncompressed voice signal, assigns emotional values to the extracted signals, and reports the emotion. U.S. Pat. No. 3,855,416 to Fuller measures emotional stress in speech by analyzing the presence of vibrato or rapid modulation. Neither Pertrushin nor Fuller disclose means of analyzing the emotional content of compressed voice signals. Thus, there is a need in the art for means and methods of analyzing the emotional content of compressed telecommunication signals.

### BRIEF SUMMARY OF THE INVENTION

The present invention overcomes shortfalls in the related art by providing means and methods of analyzing the emotional content of compressed telecommunication signals. Today, most telecommunication signals undergo compression, which often occurs within the handset of the user. The compressed signals are then transmitted over the telecommunications network. The receiver receives this compressed signal and decompresses it in the handset of the far-end user. The invention takes advantage of the compressed nature of the signal to achieve new efficiencies in power consumption and hardware costs to sample less data after compression as compared to the prior art sampling of non-compressed data.

In one aspect of the invention, the extracted voice feature is compared to the features in the database to identify the emotion of the compressed communication signal.

In another aspect of the invention, the features that are extracted are zero crossing rate, frequency range (150-300 Hz and 600-1200 Hz), variations in the frequency range etc.

In a typical modern wireless telecommunications system a voice signal may be compressed from approximately 64 kb to 10 kb per second. Due to the lossly compression methods typically used today, not all information is transferred into the compressed voice signal. To accommodate the loss of data, novel signal processing techniques are used to improve signal quality and to detect the transmitted emotion.

In a compressed voice signal, the invention, as implemented within a cell phone handset, measures the fundamental frequency of the parties of the conversation. Differences in pitch, tambour, stability of pitch frequency, volume, amplitude and other factors are analyzed to detect emotion and/or deception of the speaker.

If the cordless phones are connected to VoIP telephone lines, the signals are compressed before sending them over the VoIP networks.

If a Bluetooth headset/handsfree car kit is paired to a Bluetooth enabled telecommunications device, the signal from the headset/car kit undergoes Bluetooth compression.

Vocoder or other similar hardware may be used to analyze a compressed voice signal. After an emotion is detected, the emotional quality of the speaker may be visually reported to the user of the handset.

These and other objects and advantages will be made apparent when considering the following detailed specification when taken in conjunction with the drawings.

### BRIEF DESCRIPTION OF THE DRAWINGS

FIG. 1a shows various embodiments of the Machine for Emotion Detection (MED) as described herein.

FIG. 1b shows the general block diagram of a microprocessor system.

FIG. 2 shows the application of MED in a Bluetooth headset.

FIG. 3 shows the application of MED in a cell phone.

FIG. 4 shows the application of MED in a cordless phone.

FIG. 5, from Fuller, is an oscillograph of a male voice responding with the word “yes” in the English language, in answer to a direct question at a bandwidth of 5 kHz.

FIG. 6, from Fuller is an oscillograph of a male voice responding with the word “no” in the English language in answer to a direct question at a bandwidth of 5 kHz.

FIGS. 7a and 7b, from Fuller are oscillographs of a male voice responding “yes” in the English Language as measured in the 150-300 Hz and 600-1200 Hz frequency regions, respectively.

FIGS. 8a and 8b, from Fuller are oscillographs of a male voice responding “no” in the English language as measured in the 150-300 Hz and 600-1200 Hz frequency regions, respectively.

FIG. 9 is a schematic diagram of a hardware implementation of one embodiment of the present invention wherein a vocoder is used for analysis of compressed voice signals.

FIG. 10 is a flowchart depicting one embodiment of the present invention that detects emotion using compressed voice signals after decompression.

### DETAILED DESCRIPTION OF THE INVENTION

In one embodiment of the invention, a system or device receives uncompressed voice signals, performs lossly compression upon the signal, extracts certain elements or frequencies from the compressed signal, measures variations in the extracted compressed components, assigns an emotional state to the analyzed speech, and reports the emotional state of the analyzed speech.

The time domain signal is converted to frequency domain signal using known techniques such as Fast Fourier Transform (FFT). After performing FFT on the signal, certain frequency regions are extracted. If the signal is sampled at 8000 Hz and 256 point FFT is performed on it, the resolution of the FFT is given by:

$$FFT Resolution = \frac{Sampling Frequency}{Number of FFT Point}$$

$$FFT Resolution = \frac{8000}{256} = 31.25 Hz$$

In other words, each FFT bin is 31.25 Hz or there are 256 bins from 0-8000 Hz (256×31.25=8000)

FFT bin number 5 corresponds to approximately 150 Hz (31.25×5) and FFT bin number 16 corresponds to 500 Hz (31.25×16). So if we have to extract the frequency ranges from 150 Hz to 300 Hz, we use FFT bin 5 to FFT bin 10. To extract frequency ranges from 600 Hz to 1200 Hz, we use FFT bin 19 to 39.

A database of emotions is stored in telecommunication devices' memory. The extracted voice feature is compared to the features in the database to identify the emotion of the compressed communication signal. This database is created with a group of people which includes various age groups, accents, males, females etc. The comparison of the extracted voice feature with the emotions in the database is done in real time. The extracted voice feature should be matching at least N % with the emotion in the database. N can be in the range of 75-100%.

The variations in the extracted frequency regions are measured. The measurement of variations include finding the amplitude of the particular frequency bin (example FFT bin 5) and comparing it with the amplitude of another frequency bin (example FFT bin 10).

The zero crossing rate of the received communication signal is calculated. The zero crossing rate is calculated as follows:

a) Take N samples of the compressed signal for analysis. N can be in the

range 80-320.

b) for i = 1 to N

if ( current input sample x next input sample > 0)

increment the counter;

else

don't increment the counter ;

end loop

The counter calculated is compared to a pre-defined threshold. This threshold can in the range 30-100 depending on the value of N (as defined in previous paragraph).

The invention also includes means to restore some data elements after the voice signal goes through lossly compression.

Hardware Overview

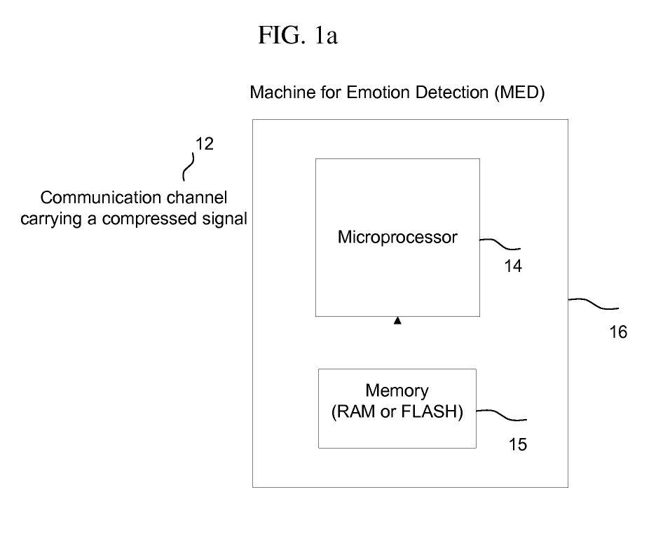

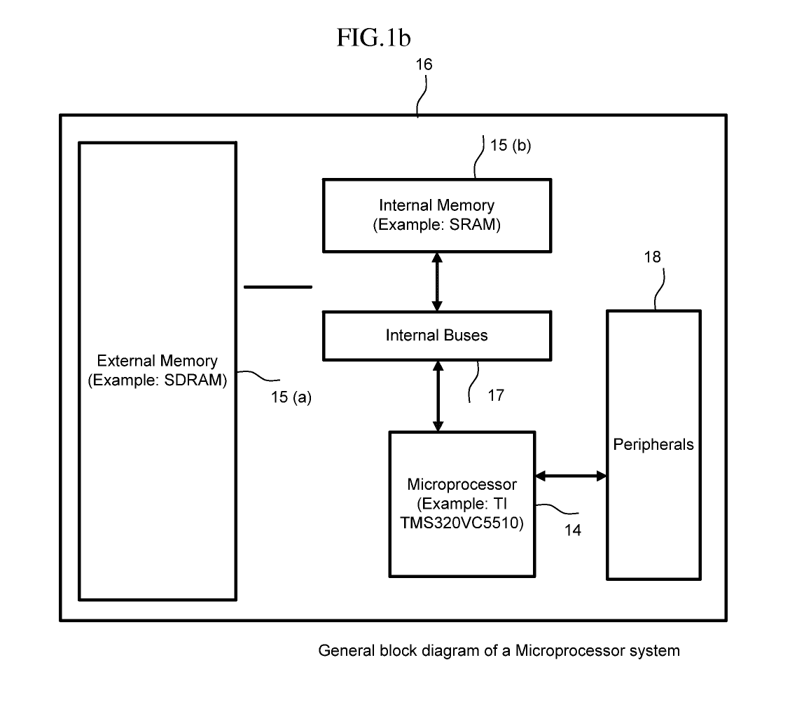

FIG. 1a shows the embodiments of the Machine for Emotion Detection (MED) as described in the current invention. The transducer/microphone of the communication device picks up the analog signal. The Analog to Digital Converter (ADC converts the analog signal to digital signal. The signal undergoes compression and is transmitted. On the receiver, the compressed signal is received and analyzed. The compressed signal is then sent to the MED, block 16. In general any communication signal received from a communication device, in its digital form, is sent to the MED. The MED (block 16) consists of a microprocessor, block 14 and a memory, block 15. The microprocessor can be a general purpose Digital Signal Processor (DSP), fixed point or floating point, or a specialized DSP (fixed point or floating point).

Examples of DSP include Texas Instruments (TI) TMS320VC5510, TMS320VC6713, TMS320VC6416 or Analog Devices (ADI) BF531, BF532, 533 etc or Cambridge Silicon Radio (CSR) BlueCore 5 Multi-media (BC5-MM) or BC7-MM. In general, the MED can be implemented on any general purpose fixed point/floating point DSP or a specialized fixed point/floating point DSP. The memory can be Random Access Memory (RAM) based or FLASH based and can be internal (on-chip) or external memory (off-chip). The instructions reside in the internal or external memory. The microprocessor, in this case a DSP, fetches instructions from the memory and executes them.

FIG. 1b shows the embodiments of block 16. It is a general block diagram of a DSP system where MED is implemented. The internal memory, block 15 (b) for example, can be SRAM (Static Random Access Memory) and the external memory, block 15 (a) for example, can be SDRAM (Synchronous Dynamic Random Access Memory). The microprocessor, block 14 for example, can be TI TMS320VC5510. However, those skilled in the art, can appreciate the fact that the block 14, can be a microprocessor, a general purpose fixed/floating point DSP or a specialized fixed/floating point DSP. The internal buses, block 17, are physical connections that are used to transfer data. All the instructions to detect the emotion reside in the memory and are executed in the microprocessor and are displayed in the peripherals (block 18).

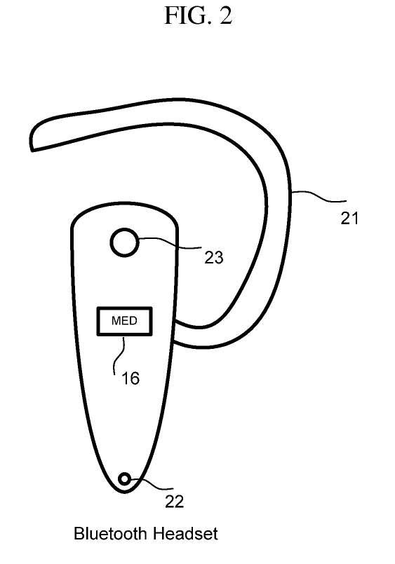

FIG. 2 shows a Bluetooth headset with MED. In FIG. 2, 22 is the microphone of the device. 23 is the speaker of the device. 21 is the ear hook of the device. Block 16 is the MED which decides the emotion of the communication signal. The information is then transmitted to the communications device which is paired to Bluetooth headset and is displayed on the communication device.

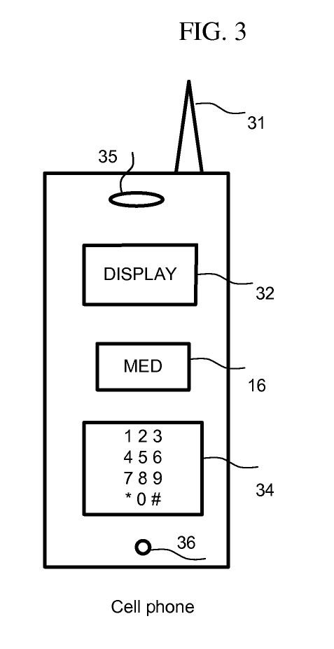

FIG. 3 shows a cell phone with MED. In FIG. 3, 31 is the antenna of the cell phone, 35 is the loudspeaker. 36 is the microphone. 32 is the display, 34 is the keypad of the cell phone. Block 16 is the MED which decides the emotion of the communication signal. The emotion is then displayed on the block 32.

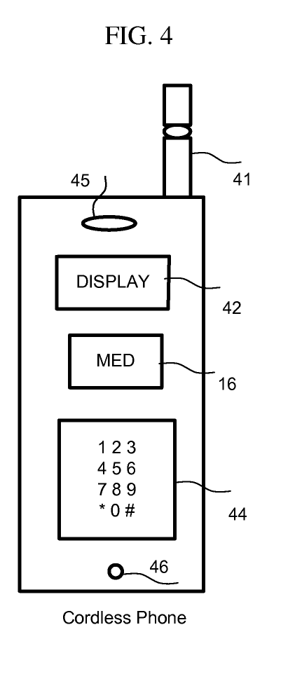

FIG. 4 shows a cordless phone with MED. In FIG. 4, 41 is the antenna of the cell phone, 45 is the loudspeaker. 46 is the microphone. 42 is the display, 44 is the keypad of the cell phone. Block 16 is the MED which decides the emotion of the communication signal which is displayed on block 42.

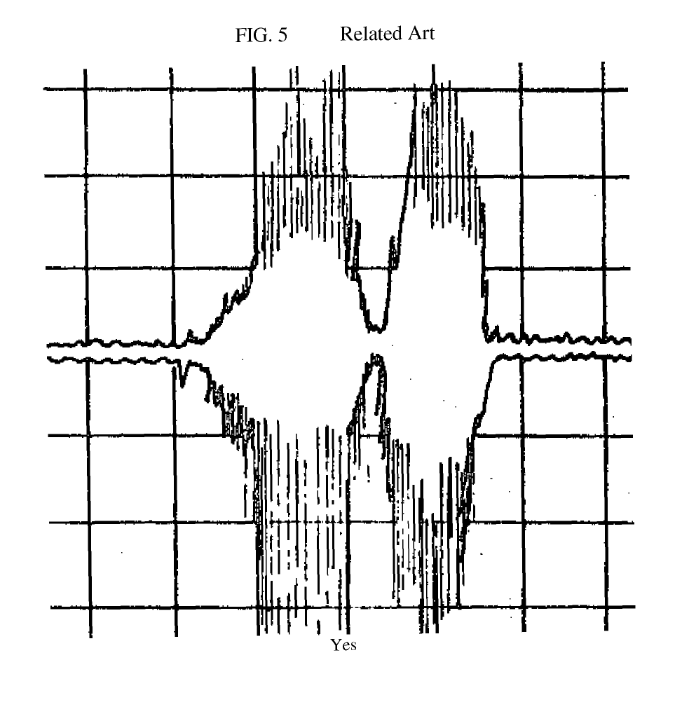

FIG. 5, from Fuller, is an oscillograph of a male voice responding with the word “yes” in the English language, in answer to a direct question at a bandwidth of 5 kHz.

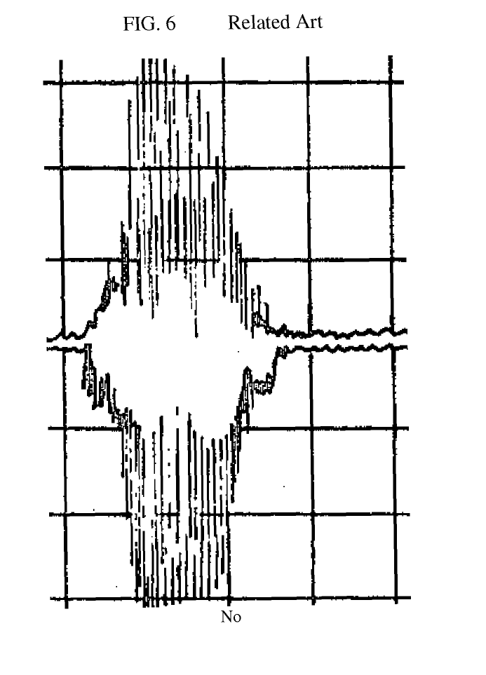

FIG. 6, from Fuller is an oscillograph of a male voice responding with the word “no” in the English language in answer to a direct question at a bandwidth of 5 kHz.

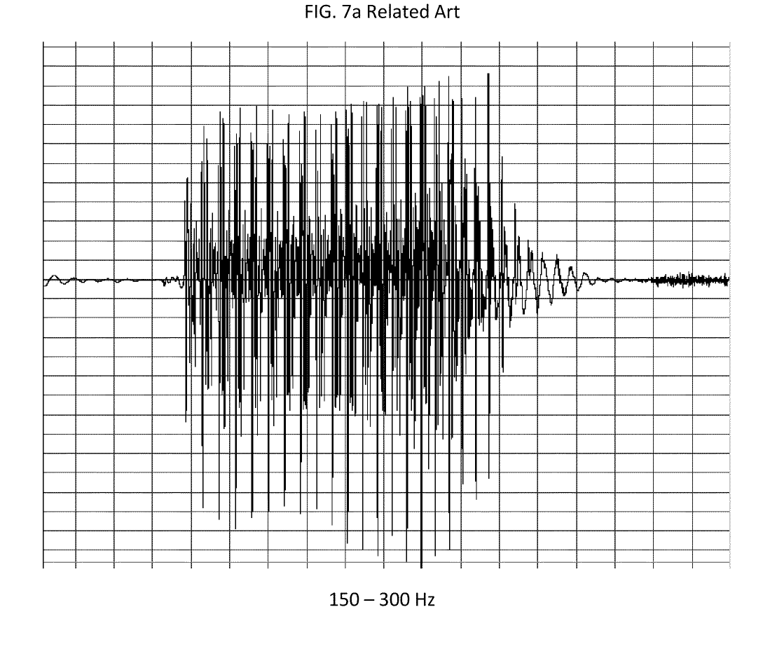

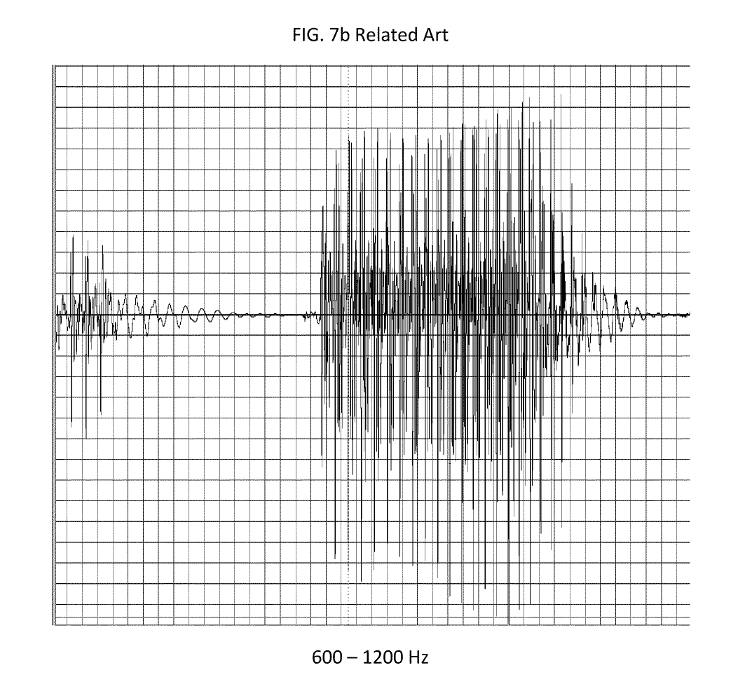

FIGS. 7a and 7b, from Fuller are oscillographs of a male voice responding “yes” in the English Language as measured in the 150-300 Hz and 600-1200 Hz frequency regions, respectively.

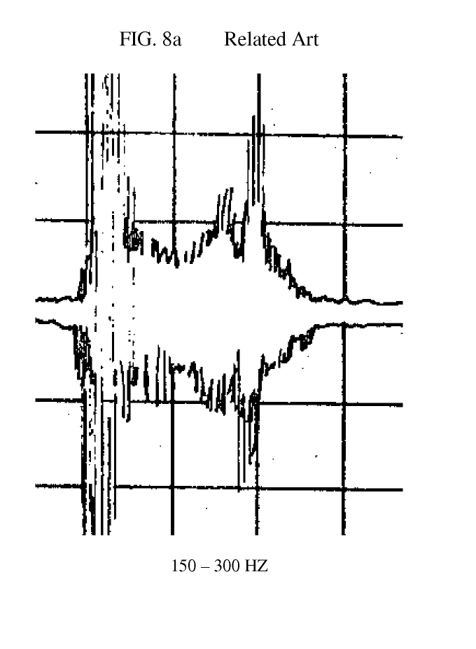

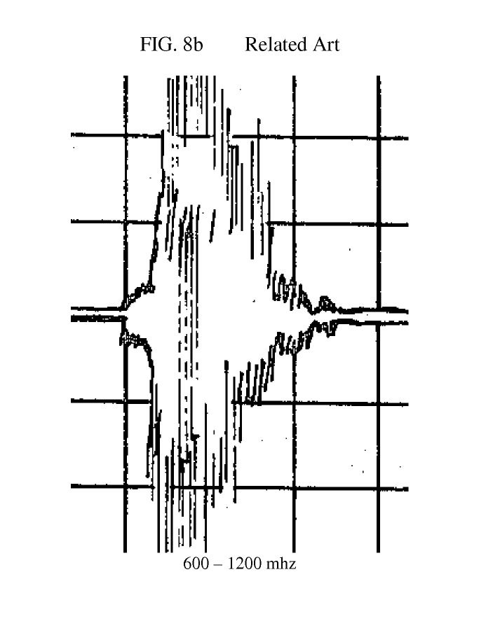

FIGS. 8a and 8b, from Fuller are oscillographs of a male voice responding “no” in the English language as measured in the 150-300 Hz and 600-1200 Hz frequency regions, respectively.

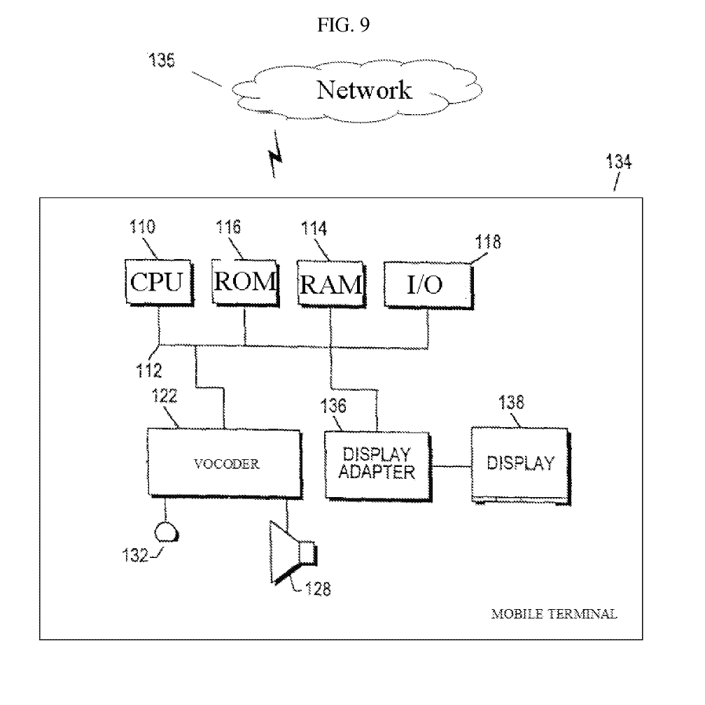

The analysis of compressed speech may occur in a vocoder 122 as implemented in FIG. 9. which illustrates a typical hardware configuration of a mobile device having a central processing unit 110, such as a microprocessor, and a number of other units interconnected via bus 112, and includes Random Access Memory (RAM) 114, Read Only Memory (ROM) 116, an I/O adapter 118 for connecting peripheral devices such as memory storage units to the bus 112, a voce coder (vocoder) that is the interface of speaker 128, a microphone 132, and a display adapter 136 for connecting the bus 112 to a display device or screen 138.

Other analogous hardware configurations are contemplated.

Methodology Overview

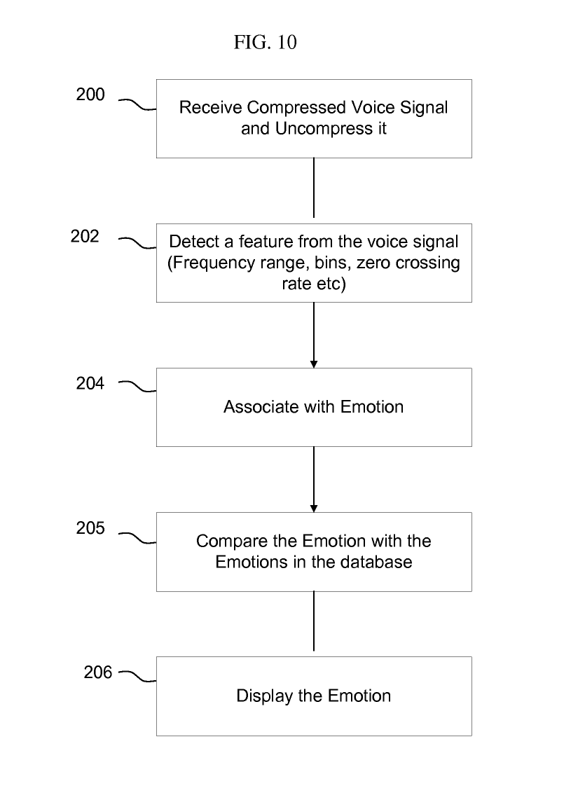

The steps of the disclosed method are outlined in FIG. 10, and include block 200 wherein the step of compression is added to achieve new economies of power consumption and efficiencies in utilizing existing hardware. Block 200 includes the step of decompression.

A telecommunication device, such as a cell phone or voice over internet protocol, or voice messenger, or handset may receive 200 a voice signal from a network or other source. Unlike the related art, the present invention then compresses the voice signal and then decompresses the voice signal before performing an analysis of emotional content. Block 200 may also include means using an efficient lossly compression system and means of recovering lost data elements.

At block 202 at least one feature of the uncompressed voice signal is extracted to analyze the emotional content of the signal. However, unlike Pertrushin, the extracted signal has been compressed and decompressed.

At block 204 an emotion is associated with the characteristics of the extracted feature. However, unlike Pertrushin, due to compression and decompression, less bandwidth needs to be analyzed as compared to the related art.

At block 205, the associated emotion is compared with the emotions stored in the database. The associated emotion should match at least N % with the emotion in the database. N can be in the range of 75-100.

At block 206 the assigned emotion is conveyed to the user of the device.

### DETAILED ANALYSIS OF IMPROVEMENTS TO THE RELATED ART

After lossly compression, data reconstruction and/or decompression, streamlined extraction of data, selection of data elements to analyze, and other steps, the invention uses some of the known art to assign an emotional state to voice signal.

In one alternative embodiment, Fuller's technique from U.S. Pat. No. 3,855,416 may be used to analyze a voice signals' stress and vibrato content. FIGS. 5 to 8b from Fuller, as presented herein, demonstrate several basic principles of voice analysis, but do not address the use of compression and other methods as disclosed in the present invention.

After compression and decompression, traditional methods of emotion detection may be employed, such as the methods of Fuller, some of which are described herein.

Phonation and Formants

The definitions of “Phonation” and “Formants” are well stated in Fuller:
Speech is the acoustic energy response of: (a) the voluntary motions of the vocal cords and the vocal tract which consists of the throat, the nose, the mouth, the tongue, the lips and the pharynx, and (b) the resonances of the various openings and cavities of the human head. The primary source of speech energy is excess air under pressure, contained in the lungs. This air pressure is allowed to flow out of the mouth and nose under muscular control which produces modulation. This flow is controlled or modulated by the human speaker in a variety of ways.

The major source of modulation is the vibration of the vocal cords. This vibration produces the major component of the voiced speech sounds, such as those required when conus the vowel sounds in a normal manner. These voiced sounds, formed by the buzzing action of the vocal cords, contrast to the voiceless sounds such as the letter s or the letter f produced by the nose, tongue and lips. This action of voicing is known as “phonation.”

The basic buzz or pitch frequency, which establishes phonation, is different for men and woman. The vocal cords of a typical adult male vibrate or buzz at a frequency of about 120 Hz, whereas for women this basic rate is approximately an octave higher, near 250 Hz. The basic pitch pulses of phonation contain many harmonics and overtones of the fundamental rate in both men women.

The vocal cords are capable of a variety of shapes and motions. During the process of simple breathing, they are involuntarily held open and during phonation, they are brought together. As air is expelled from the lungs, at the onset of phonation, the vocal cords vibrate back and forth, alternately closing and opening. Current physiological authorities hold that the muscular tension and the effective mass of the cords is varied by learned muscular action. These changes strongly influence the oscillating or vibrating system.

Certain physiologists consider that phonation is established by or governed by two different structures in the pharynx, i.e., the vocal cord muscles and a mucous membrane called the cones elasticus. These two structures are acoustically coupled together at a mutual edge within the pharynx, and cooperate to produce two different modes of vibration.

In one mode, which seems to be an emotionally stable or non-stressful timbre of voice, the conus elasticus and the vocal cord muscle vibrate as a unit in synchronism. Phonation in this mode sounds “soft” or “mellow” and few overtones are present.
In the second mode, a pitch cycle begins with a subglottal closure of the conus elasticus. This membrane is forced upward toward the coupled edge of the vocal cord muscle in a wave-like fashion, by air pressure being expelled from the lungs. When the closure reaches the coupled edge, a small puff of air “explosively” occurs, giving rise to the “open” phase of vocal cord motion. After the “explosive” puff of air has been released, the subglottal closure is pulled shut by a suction which results from the aspiration of air through the glottis. Shortly after this, the vocal cord muscles also close. Thus in this mode, the two masses tend to vibrate in opposite phase. The result is a relatively long closed time, alternated with short sharp air pulses which may produce numerous overtones and harmonics.
The balance of respiratory tract and the nasal and cranial cavities give rise to a variety of resonances, known as “formants” in the physiology of speech. The lowest frequency format can be approximately identified with the pharyngeal cavity, resonating as a closed pipe. The second formant arises in the mouth cavity. The third formant is often considered related to the second resonance of the pharyngeal cavity. The modes of the higher order formants are too complex to be very simply identified. The frequency of the various formants varies greatly with the production of the various voiced sounds.

Vibrato

In testing for veracity or in making a Truth/Lie decision, the vibrato component of speech may have a very high correlation with the related level of stress or emotional state of the speaker. FIG. 5, from Fuller is an oscilloghraph of a male voice stating “yes” at a bandwidth of 5 kHz. As pointed out by Fuller:
The wave form contains two distinct sections, the first being for the “ye” sound and the second being for the unvoiced “s” sound. Since the first section of the “yes” signal wave form is a voiced sound being produced primarily by the vocal cords and conus elasticus, this portion will be processed to detect emotional stress content or vibratto modulation. The male voice responding with the word “no” in the English language at a bandwidth of 5 kHz is shown in FIG. 6.

The single voiced section may be analyzed to measure the vibrato of the phonation constituent of the speech signal.

The spectral region of 150-300 Hz comprises a significant amount of the fundamental energy of phonation. FIGS. 7a to 8b from Fuller, as presented herein, show an oscillograph of the same voice in FIGS. 5 and 6 as measured in the 150-300 Hz frequency region.

Advantages of Compression in Relation to Relevant Frequencies or “Formants” Generated by Human Speech

Pertrushin identifies three significant frequency bands of human speech and defines these bands as “formants”. While Pertrushin describes a system to use the first formant band of the top end of the fundamental “buzz” frequency of 240 Hz to approximately 1000 Hz, Pertrushin fails to even consider the need of efficiently extracting the useful bandwidths of speech sounds. By use of the present invention, signal compression and other techniques are used to efficiently extract the most useful “formants” or energy distributions of human speech.

Pertushin gives a good general overview of the characteristics of human speech, stating:
Human speech is initiated by two basic sound generating mechanisms. The vocal cords; thin stretched membranes under muscle control, oscillate when expelled air from the lungs passes through them. They produce a characteristic “buzz” sound at a fundamental frequency between 80 Hz and 240 Hz. This frequency is varied over a moderate range by both conscious and unconscious muscle contraction and relaxation. The wave form of the fundamental “buzz” contains many harmonics, some of which excite resonance is various fixed and variable cavities associated with the vocal tract. The second basic sound generated during speech is a pseudo-random noise having a fairly broad and uniform frequency distribution. It is caused by turbulence as expelled air moves through the vocal tract and is called a “hiss” sound. It is modulated, for the most part, by tongue movements and also excites the fixed and variable cavities. It is this complex mixture of “buzz” and “hiss” sounds, shaped and articulated by the resonant cavities, which produces speech.
In an energy distribution analysis of speech sounds, it will be found that the energy falls into distinct frequency bands called formants. There are three significant formants. The system described here utilizes the first formant band which extends from the fundamental “buzz” frequency to approximately 1000 Hz. This band has not only the highest energy content but reflects a high degree of frequency modulation as a function of various vocal tract and facial muscle tension variations.
In effect, by analyzing certain first formant frequency distribution patterns, a qualitative measure of speech related muscle tension variations and interactions is performed. Since these muscles are predominantly biased and articulated through secondary unconscious processes which are in turn influenced by emotional state, a relative measure of emotional activity can be determined independent of a person's awareness or lack of awareness of that state. Research also bears out a general supposition that since the mechanisms of speech are exceedingly complex and largely autonomous, very few people are able to consciously “project” a fictitious emotional state. In fact, an attempt to do so usually generates its own unique psychological stress “fingerprint” in the voice pattern.

Thus, the utility of efficiently extracting only the relevant formants or frequency distributions is evident. The use of compression and other methods, as disclosed herein are well suited to take advantage of the relatively narrow bandwidths of relevant frequencies.

Embodiments of the invention include the following items:

Item 1. A specialized machine for emotion detection, the machine comprising:

a) transducer or microphone for accepting an analog signal;
b) an analog to digital converter (ADC) for converting the analog signal to a digital signal;
c) a digital signal processor to compress the digital signal;
d) a digital signal processor to decompress the digital signal;
e) a vocoder used to detect signal features indicative of emotion within of the decompressed digital signal by:
i. converting the decompressed digital signal from a time domain signal to a frequency domain signal;
ii. extracting a number of frequency ranges from the frequency domain signal;
iii. measuring variations in the extracted frequency regions, from the group of variations comprising: amplitude, and zero crossing rate;
   f) a first database to store the measured variations in the extracted frequency regions;
   g) a second database of previously measured variations of frequency regions of decompressed signals with emotion values associated with the previously measured variations of frequency regions;
   i) a microprocessor unit used to compare measured variations of the first database to stored variations of the second database and to report any matching variations and any associated emotion values from the second database.

The machine of item 1 wherein the measured variations of the extracted frequency regions includes the measurement of the amplitude of a particular frequency bin and comparing the value to the amplitude of a similar frequency bin stored within the second database.

The machine of item 1 wherein the zero crossing rate is derived as follows:

a) capturing N samples of the digital signal, wherein N is a value within the range of 80 to 320; and
b) for i=1 to N
if (current input sample×next input sample>0)
increment a counter;
else
don't increment the counter;
end loop;
c) the counter calculated value is compared to a pre-defined threshold, the pre-defined threshold being in the range of 30 to 100.

The machine of item 1 wherein measured variations are obtained from features that are extracted at a zero crossing rate at frequency ranges of 150 to 300 Hz and at 600 to 1200 Hz.

The machine of item 1 wherein the time domain signal is converted to frequency domain signal using fast fourier transform.

The machine of item 1 wherein after the digital signal is modulated by FFT, certain frequency regions are extracted as follows:

if the signal is sampled at 8000 Hz and 256 point FFT is used, the resolution of the FFT is obtained by:

$$FFT Resolution = \frac{Sampling Frequency}{Number of FFT Point}$$

$$FFT Resolution = \frac{8000}{256} = 31.25 Hz$$

such that if each FFT bin is 31.25 Hz or there are 256 bins from 0-8000 Hz (256×31.25=8000).

What is claimed is:

1. A specialized machine for emotion detection, the machine comprising:
a) transducer or microphone for accepting an analog signal;
b) an analog to digital converter (ADC) for converting the analog signal to a digital signal;
c) a digital signal processor to compress the digital signal;
d) a digital signal processor to decompress the digital signal;
e) a vocoder used to detect signal features indicative of emotion within of the decompressed digital signal by:
i. converting the decompressed digital signal from a time domain signal to a frequency domain signal;
ii. extracting a number of frequency ranges from the frequency domain signal;
iii. measuring variations in the extracted frequency regions, from the group of variations comprising: amplitude, and zero crossing rate;
f) a first database to store the measured variations in the extracted frequency regions;
g) a second database of previously measured variations of frequency regions of decompressed signals with emotion values associated with the previously measured variations of frequency regions;
i) a microprocessor unit used to compare measured variations of the first database to stored variations of the second database and to report any matching variations and any associated emotion values from the second database.

2. The machine of claim 1 wherein the measured variations of the extracted frequency regions includes the measurement of the amplitude of a particular frequency bin and comparing the value to the amplitude of a similar frequency bin stored within the second database.

3. The machine of claim 1 wherein the zero crossing rate is derived as follows:
a) capturing N samples of the digital signal, wherein N is a value within the range of 80 to 320; and
b) for i=1 to N
if (current input sample×next input sample>0)
increment a counter;
else
don't increment the counter;
end loop;
c) the counter calculated value is compared to a pre-defined threshold, the pre-defined threshold being in the range of 30 to 100.

4. The machine of claim 1 wherein measured variations are obtained from features that are extracted at a zero crossing rate at frequency ranges of 150 to 300 Hz and at 600 to 1200 Hz.

5. The machine of claim 1 wherein the time domain signal is converted to frequency domain signal using fast fourier transform.

6. The machine of claim 1 wherein after the digital signal is modulated by FFT, certain frequency regions are extracted as follows:
if the signal is sampled at 8000 Hz and 256 point FFT is used, the resolution of the FFT is obtained by:
$$FFT Resolution = \frac{Sampling Frequency}{Number of FFT Point}$$
$$FFT Resolution = \frac{8000}{256} = 31.25 Hz$$
such that if each FFT bin is 31.25 Hz or there are 256 bins from 0-8000 Hz (256×31.25=8000).
